(19) United States
(12) Patent Application Publication
(10) Pub. No.: US 2015/0339678 A1
(43) Pub. Date: Nov. 26, 2015

(54) CORRESPONDENT BANKING NETWORK ANALYSIS FOR PRODUCT OFFERING

(71) Applicant: International Business Machines Corporation, Armonk, NY (US)

(72) Inventors: Arun Hampapur, Norwalk, CT (US); Hongfei Li, Briarcliff Manor, NY (US); Robin Lougee, Yorktown Heights, NY (US); Buyue Qian, Ossining, NY (US)

(73) Assignee: International Business Machines Corporation, Armonk, NY (US)

(21) Appl. No.: 14/284,036

(22) Filed: May 21, 2014

(51) Int. Cl. G06Q 30/02

(52) U.S. Cl. CPC G06Q 30/0201; G06Q 40/02

(57) ABSTRACT

A system, method and program product are provided for evaluating clients in a correspondent banking (CB) network with regard to CB product offerings. The disclosed system includes: a network modeling system that creates a model of a CB network, wherein the model is defined by a set of banks and a set of clients based on existing relationships among and between the banks and clients, and wherein the model is further defined with inputted risk data, expected return data, demand data, and cost data; and an evaluation engine that utilizes the model to generate a clientele evaluation for an inputted CB product offering within the CB network, wherein the evaluation engine determines a potential economic benefit of each client with regard to the inputted CB product offering.

### TECHNICAL FIELD

The subject matter of this invention relates generally to product offerings within a correspondent banking network, and more particularly relates to an evaluation system and method for evaluating clients within a correspondent banking network to maximize product offering results.

### BACKGROUND

Correspondent banking refers to a scenario in which a financial institution (i.e., bank) provides services on behalf of another, equal or unequal, financial institution. A correspondent bank can conduct business transactions, accept deposits and gather documents on behalf of the other financial institution. Correspondent banks are more likely to be used to conduct business in foreign countries, and act as a domestic bank's agent abroad. In many cases, a transaction such as an international money transfer can involve intermediate transactions among multiple institutions along a network of banks having existing relationships with each other.

Currently, correspondent banking services continues to be a high growth area, with significant profit potential. However, current approaches used to market correspondent banking services to potential clients lack intelligence, particularly for smaller, non-institutional entities. Without such intelligence, banks are not able to effectively market such services, thus reducing potential profits.

### SUMMARY

In general, aspects of the present invention provide a solution for analyzing and evaluating clients for various product offerings within a correspondent banking network. Based on an analysis of available products and the behaviors of clients in the context of a correspondent banking network, the solution infers the demand of products, estimates the risk associated with clients, predicts an expected return, and calculates the cost of an offering. A client analysis, such as a ranked list of clients, is then generated for each product offering, where the goal is identify clients likely to maximize profit and reduce risk.

A first aspect of the invention provides a system for evaluating clients in a correspondent banking (CB) network with regard to CB product offerings, comprising: a network modeling system that creates a model of a CB network, wherein the model is defined by a set of banks and a set of clients based on existing relationships among and between the banks and clients, wherein the model is further defined with inputted risk data, expected return data, demand data, and cost data; and an evaluation engine that utilizes the model to generate a clientele evaluation for an inputted CB product offering within the CB network, wherein the evaluation engine determines a potential economic benefit of each client with regard to the inputted CB product offering.

A second aspect of the invention provides a computer program product stored on computer readable medium, which when executed by a computer system, evaluates clients in a correspondent banking (CB) network with regard to CB product offerings, comprising: program code that creates a model of a CB network, wherein the model is defined by a set of banks and a set of clients based on existing relationships among and between the banks and clients, and wherein the model is further defined with at least one of inputted risk data, expected return data, demand data, and cost data; and program code that utilizes the model to generate a clientele evaluation for an inputted CB product offering within the CB network, wherein a potential economic benefit of each client is determined with regard to the inputted CB product offering.

A third aspect of the invention provides a computerized method of evaluating clients in a correspondent banking (CB) network with regard to CB product offerings, comprising: creating a model of a CB network, wherein the model is defined by a set of banks and a set of clients based on existing relationships among and between the banks and clients, and wherein the model is further defined with inputted risk data, expected return data, demand data, and cost data; and generating a clientele evaluation for an inputted CB product offering within the CB network based on the model, wherein a potential economic benefit of each client is determined with regard to the inputted CB product offering.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative computer system having a correspondent banking product marketing system according to embodiments of the present invention.

FIG. 2 shows a model of a correspondent banking network with weighted edges according to embodiments of the invention.

FIG. 3 shows a flow diagram depicting a method of evaluating clients in a correspondent banking network according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

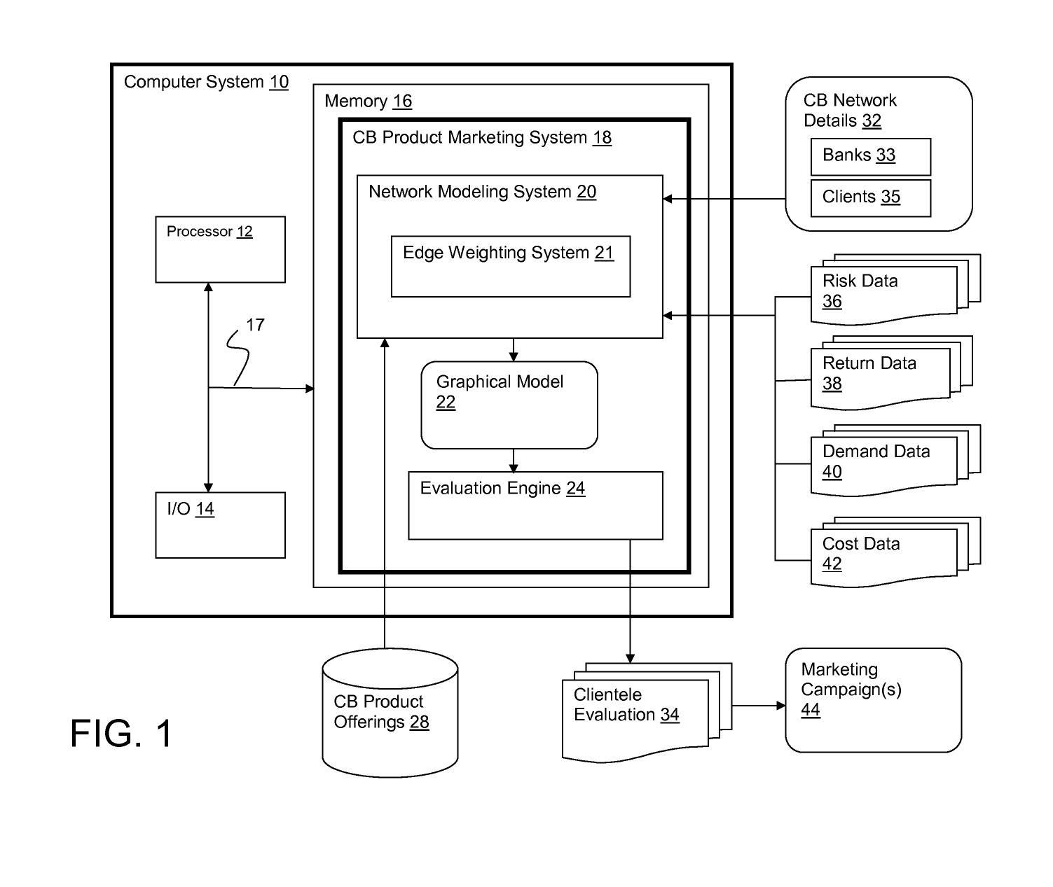

FIG. 1 depicts a computer system 10 having a correspondent banking (CB) product marketing system 18 for “evaluating” a set of clients 35 known to do business with one or more banks 33 in a CB network. In particular, a given bank 33 (or other entity) may have CB product offerings 28 that it would like to sell to its clients as well as clients of other banks within the CB network (collectively referred to as “network clientele” or “clientele”). CB product marketing system 18 provides a process that outputs a clientele evaluation 34 all of the clients 35 within the CB network for each given CB product offering. Clients 35 can be, e.g., ranked, rated, scored, sorted, selected, etc., based on potential economic benefit, within the clientele evaluation 34. Using CB product marketing system 18, a bank 33 can thus for example identify the most qualified leads, i.e., clients with the most potential economic benefit, for an upcoming marketing campaign 44.

In this illustrative embodiment of FIG. 1, the clientele evaluation 34 may for example include ranked listings of clients 35 for each of a plurality of CB product offerings 28. Each ranked listing may for example include the network clientele, sorted according to some measure (e.g., score, ranking, etc.). The measure may for example assess: a client's likelihood of purchasing a product relative to the other clients; an expected return on investment (ROI) rate; associated risk, demand, etc. That data can then be utilized by a marketing campaign 44 to focus marketing resources at the best clients.

CB product offerings 28 may comprise any set of products and/or services sold by banks 33 (or other entities) within the CB network. Illustrative products may include foreign exchange (FX) wire transfers, monthly transfer subscriptions, wire transfer bundling options, expedited services, insurance products, escrow products, loan products, deposit products, etc.

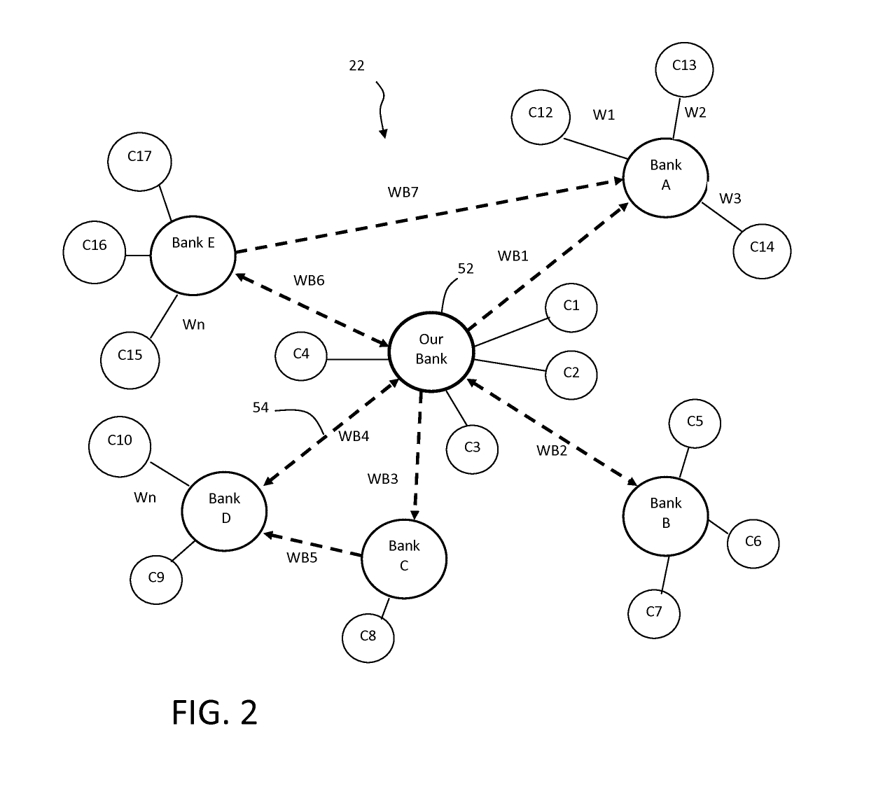

CB product marketing system 18 generally includes a network modeling system 20 that generates a graphical model 22 of a CB network based on inputted CB network details 32, including banks 33 belonging the CB network and known clients 35 of the banks Referring also to FIG. 2, a graphical model 22 of an illustrative CB network is shown comprising a plurality of banks (e.g., Our Bank 52, Bank A, Bank B, . . . Bank E) that are able to receive and route transactions between and among each other. Also included in CB network are known clients of the various banks (e.g., C1, C2, . . . C17). In this case, the graphical model 22 is implemented as a directed graph in which banks are denoted as a first (larger) type of node and clients are denoted as a second (smaller) type of node. Available bank-to-bank transaction routes are denoted as bank edges (shown in dashed lines). Additional edges are utilized to establish a relationship between clients and each bank. Thus for example, if client C1 (a client of Our Bank 52) needed to wire funds to client C9 (a client of Bank D), the transaction could occur directly between Our Bank 52 and Bank D, or via Bank C. Similarly, if client C17 needed to wire money to client C6, Bank E might route the transaction through Our Bank 52, and then to Bank B. In more complex CB scenarios, transactions may be routed through several banks.

Any known computerized tool or system may be utilized by network modeling system 20 to build the graphical model 22, and such tools are widely available in the art. CB network details 32 may for example comprise a table of banks 33 in the network, along with details regarding the relationships each bank has with other banks 33 in the network. For instance, most banks 33 in the network will only have relationships with a subset of the other banks 33 in the network, and each of those relationships may only allow for certain types of transactions. The identity of the clients 35 can be ascertained in any manner. For example, by examining transactions being routed throughout the CB network over time, a set of known clients within the network can be readily determined.

Each edge is assigned a weight for each CB product by edge weighting system 21. Weights along edges between each bank and its clients (client edges) are determined based on a set of inputted data factors, including, for example, risk data 36, expected return data 38, demand data 40 and cost data 42. Accordingly, as shown in FIG. 2, each client edge between Bank A and its clients C12, C13, C14 is assigned a unit weight W1, W2, W3 (for each product offering) that is an integrated value based on the four data factors. (Note that for clarity purposes not all of the client edges shown in FIG. 2 are labeled, even though each client edge is assigned a weight.)

Weights assigned to edges between banks and clients are intended to capture a relative potential economic benefit of each client in a marketing campaign based on risk data 36, expected return data 38, demand data 40 and cost data 42. Risk data 36 generally includes settlement risk, i.e., the risk one party to a foreign exchange transaction will deliver the currency it sold, but not receive the purchased currency from the other party, resulting in a loss of principal. In this case, each client can be assigned a risk rating based on existing data, such as a client profile, product information, a credit report, client transaction history, etc.

Expected return data 38 generally rates the likelihood of a client purchasing a given product and how much profit can be generated if a purchase is made. In this case, each client can be assigned an expected return based on client transaction history, a client profile, product information, compliance costs, regulation costs, transaction fees, exchange fees, etc.

Demand data 40 measures how much a client really needs a given product. Demand data 40 can be determined from a client profile, product information, client transaction history, real-time markets, etc.

Finally, cost data 42 is a measure of the cost to market/offer a given product, e.g., the cost of sending emails, brochures, etc. Cost data 42 may be ascertained from product information, a client profile, etc.

Client edge weights may be calculated in any manner. For example, each weight w may be calculated as a sum of four functions, w=(f1(Demand)+f2(Return)−f3(Risk)−f4(Cost)), where each function f1, f2, f3, f4 normalizes its associated result to a common mathematical scale, e.g., an integer between 0-25. Thus for example, the resulting weight W may be a value between −50 and +50. In another approach, each weight w may have two components w1 and w2, where w1=f1(Demand)+f2(Return); and w2=f3(Risk)+f4(Cost). In this manner, w1 is a measure of the potential “upside” and w2 is a measure of the potential “downside.”

Each function f1, f2, f3, f4 can further be scaled by the system or end user to adjust for particular priorities associated with a given product offering. For instance, for a particular marketing campaign, the bank may care less about risk and more about cost. Thus the risk and cost components may be scaled by the optimization engine 24, e.g., w2=0.8*f3(Risk)+1.2*f4(Cost).

In addition to weighted edges between clients and their banks, weights (e.g., WB1, WB2 . . . WB7) are also assigned to the edges between banks (bank edges). Such bank to bank weighting can be determined based on any criteria. For example, for a CB product offering involving an expedited wire transfer using Our Bank 52, the weights between banks could simply reflect the cost of executing the transaction between partner banks in the CB network. These weights can then be a factor in identifying clients who can utilize the offered service at a lower cost relative to other clients. Thus, for instance, two different clients C10 and C15 may have the same edge weighting Wn with their respective banks (Banks D and E) for a product offering by Our Bank 52. However, if the bank edge weights (WB4 and WB6) with Our Bank 52 differ, e.g., WB4 reflects a lower cost, client C10 may be preferred over client C15.

In other cases, the bank edge weighting may incorporate a risk factor, e.g., that one of the two banks will fail to fulfill its obligation. In another case, bank edge weighting can comprise an overall or composite value reflecting risk, demand, expected return and cost for all clients associated with a given bank. Thus, for example, the edge 54 between Our Bank 52 and Bank A in FIG. 2 comprises a weight W1 that reflects a composite risk, demand, expected return and cost for the set of clients C12, C13, C14.

Once the graphical model 22 is created, and all edges have been weighted, evaluation engine 24 is utilized to create clientele evaluation 34 (e.g., a ranked list) for each product offering. In one illustrative embodiment, evaluation engine 24 processes the directed graph as an electrical grid. The process generates a voltage signal at the center node (i.e., Our Bank 52 in FIG. 2) for a given product, and then propagates the signal to all other nodes on the graph via the edges. The voltage propagation is performed with respect to the edge weights on the graph. In particular, if a transaction route is risky or not very profitable, the weight of that edge will be small. This implies that most voltage would not go through that route. Hence, clients or banks who receive higher voltages are better suited to be marketed the given product.

In the case where client edge weights w are calculated as w1=f1(Demand)+f2(Return); and w2=f3(Risk)+f4(Cost), w1 might model the conductive properties of the edge, while w2 models the resistive properties of the edge.

The evaluation engine 24 may also utilize a graph diffusion process, which for example evaluates the network by harmonically propagating signals (e.g., voltage pulses) throughout different paths, i.e., sequences of nodes in the graph.

Graph diffusion can be employed by starting with one node on the graph, and then randomly traverse (i.e., walk) a sequence of other nodes on the graph according to probabilities defined by the edge weights, i.e., a higher edge weight implies there is a higher probability that the edge will be traversed. During each traverse across a sequence of nodes, the process may at any time randomly restart (i.e., jump back to the starting node) with a certain probability, which is used to constrain the final solution to be localized (starting from one node). Otherwise the solution will reduce to a global solution, i.e., irrelevant to the starting node.

After a certain number of paths have been walked, the values on the nodes will not change, resulting in a solution referred to as the steady state of the graph.

The random walk on a graph can be expressed as F^{t+1}=αWF^{t}+(1−α)Y, where F denotes the value or state of the node, W is a similarity matrix that indicates the similarity between all pairs of nodes, Y is the initial values or states of the nodes, and t indicates time at t. In other words, the state at time t is (α*one more step of random walk on the graph (i.e., the graph diffusion term))+(1+α)*the initial state, which is the impact of the initial state and 1−α is the probability of jumping back to the initial state.

A second equation, F^{∞}=(1−α) (I−αW)⁻¹Y is derived from the above equation, and indicates that the state (i.e., value on the nodes) after an infinite number of steps. It can be seen from this equation that the state will converge. If the first equation is iteratively called, after a certain number of steps it will converge to same result shown in the second equation.

There are mainly two types of nodes on the correspondent bank network, banks and clients. In employing hierarchical graph diffusion, the main procedure is as follows: First, perform graph diffusion on the bank nodes, and get a steady state of bank nodes. Then, for each bank node, perform graph diffusion on the client nodes that are connected to the bank node. In this manner, a steady state is obtained for each sub-graph, the community of each bank.

In another approach, evaluation engine 24 may be characterized as a combinatorial optimization problem or a continuous optimization problem that attempts to identify the most optimal clients 35 for a marketing campaign based on a set of separately inputted data factors. A combinatorial optimization problem utilizes a quadruple (I, f, m, g), where
I is a set of instances;
given an instance x ∈ I, f(x) is the set of feasible solutions;
given an instance x and a feasible solution y of x, m(x,y) denotes the measure of y, which is usually a positive real.
g is the goal function, and is either min or max.
   The goal is then to find for some instance x an optimal solution, that is, a feasible solution y with

m(x,y)=g{m(x,y′)|y′ ∈ f(x)}.

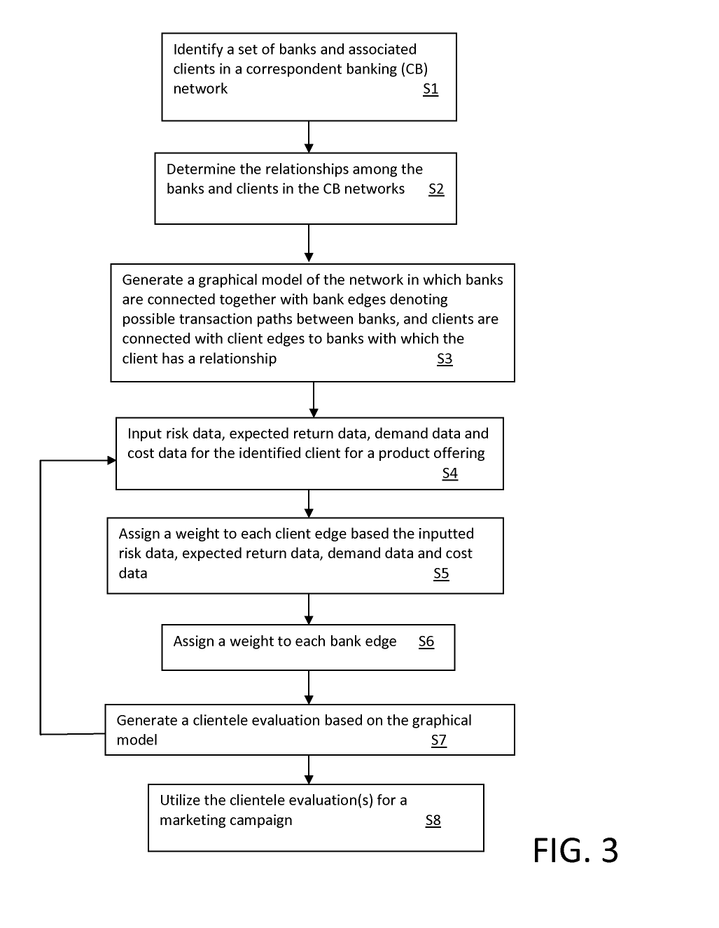

FIG. 3 depicts a flow diagram showing a computerized method of evaluating clients in a CB network. At S1, a set of banks and associated clients in a CB network are identified and at S2 the relationships among and between the banks and clients are determined. At S3, a graphical model of the network is generated in which banks are connected together with bank edges denoting possible transaction paths between banks, and clients are connected with client edges to banks with which the client has a relationship. At S4, risk data, expected return data, demand data and cost data for the identified clients are determined and inputted for a product offering. Next, at S5, a weight is assigned to each client edge based the inputted risk data, expected return data, demand data and cost data, and at S6 a weight is assigned to each bank edge. At S7, a clientele evaluation is generated based on the graphical model and associated weights. The process may loop back to S4 to generate further clientele evaluations for other product offerings. The resulting clientele evaluation(s) can thereafter be utilized for one or more marketing campaigns at S8.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts an illustrative computer system 10 that may comprise any type of computing device and, and for example includes at least one processor 12, memory 16, an input/output (I/O) 14 (e.g., one or more I/O interfaces and/or devices), and a communications pathway 17. In general, processor(s) 12 execute program code, such as CB product marketing system 18, which is at least partially fixed in memory 16. While executing program code, processor(s) 12 can process data, which can result in reading and/or writing transformed data from/to memory 16 and/or I/O 14 for further processing. Pathway 17 provides a communications link between each of the components in computer system 10. I/O 14 can comprise one or more human I/O devices, which enable a user to interact with computer system 40. To this extent, CB product marketing system 18 can manage a set of interfaces (e.g., graphical user interfaces, application program interfaces, etc.) that enable humans and/or other systems to interact with the CB product marketing system 18. Further, CB product marketing system 18 can manage (e.g., store, retrieve, create, manipulate, organize, present, etc.) data using any solution.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for evaluating clients in a correspondent banking (CB) network with regard to CB product offerings, comprising:
a network modeling system that creates a model of a CB network, wherein the model is defined by a set of banks and a set of clients based on existing relationships among and between the banks and clients, wherein the model is further defined with inputted risk data, expected return data, demand data, and cost data; and
an evaluation engine that utilizes the model to generate a clientele evaluation for an inputted CB product offering within the CB network, wherein the evaluation engine determines a potential economic benefit of each client with regard to the inputted CB product offering.

2. The system of claim 1, wherein the model comprises a directed graph in which banks are connected together with bank edges denoting possible transaction paths between banks, and clients are connected with client edges to banks with which the client has a relationship.

3. The system of claim 2, wherein each client edge includes an associated weight determined from the inputted risk data, expected return data, demand data, and cost data.

4. The system of claim 1, wherein the inputted risk data includes a settlement risk associated with a client.

5. The system of claim 1, wherein the inputted expected return data includes a likelihood of a client purchasing a given product and how much profit is generated when a purchase is made.

6. The system of claim 1, wherein the inputted demand data includes a measure of how much a client needs a given product, and the inputted cost data includes a measure of a cost to market a given product to a set of clients.

7. The system of claim 1, wherein the evaluation engine utilizes a graph diffusion process to evaluate paths through the CB network.

8. A computer program product stored on computer readable medium, which when executed by a computer system, evaluates clients in a correspondent banking (CB) network with regard to CB product offerings, comprising:
program code that creates a model of a CB network, wherein the model is defined by a set of banks and a set of clients based on existing relationships among and between the banks and clients, and wherein the model is further defined with at least one of inputted risk data, expected return data, demand data, and cost data; and
program code that utilizes the model to generate a clientele evaluation for an inputted CB product offering within the CB network, wherein a potential economic benefit of each client is determined with regard to the inputted CB product offering.

9. The computer program product of claim 8, wherein the model comprises a directed graph in which banks are connected together with bank edges denoting possible transaction paths between banks, and clients are connected by client edges to banks with which the client has a relationship.

10. The computer program product of claim 9, wherein each edge includes an associated weight determined from the inputted risk data, expected return data, demand data, and cost data.

11. The computer program product of claim 8, wherein the inputted risk data includes a settlement risk associated with a client.

12. The computer program product of claim 8, wherein the inputted expected return data includes a likelihood of a client purchasing a given product and how much profit is generated when a purchase is made.

13. The computer program product of claim 8, wherein the inputted demand data includes a measure of how much a client needs a given product, and the inputted cost data includes a measure of a cost to market a given product to a set of clients.

14. The computer program product of claim 8, wherein the program code that utilizes the model to generate the clientele evaluation for an inputted CB product offering within the CB network employs a graph diffusion process.

15. A computerized method of evaluating clients in a correspondent banking (CB) network with regard to CB product offerings, comprising:
creating a model of a CB network, wherein the model is defined by a set of banks and a set of clients based on existing relationships among and between the banks and clients, and wherein the model is further defined with inputted risk data, expected return data, demand data, and cost data; and
generating a clientele evaluation for an inputted CB product offering within the CB network based on the model, wherein a potential economic benefit of each client is determined with regard to the inputted CB product offering.

16. The computerized method of claim 15, wherein the model comprises a directed graph in which banks are connected together by edges denoting possible transaction paths between banks, and clients are connected with edges to banks with which the client has a relationship.

17. The computerized method of claim 15, wherein each edge includes an associated weight determined from the inputted risk data, expected return data, demand data, and cost data.

18. The computerized method of claim 15, wherein the inputted risk data includes a settlement risk associated with a client.

19. The computerized method of claim 15, wherein the inputted expected return data includes a likelihood of a client purchasing a given product and how much profit is generated when a purchase is made, the inputted demand data includes a measure of how much a client needs a given product, and the inputted cost data includes a measure of a cost to market a given product to a set of clients.

20. The computerized method of claim 15, wherein generating a clientele evaluation utilizes a graph diffusion process.
